(19) United States
(12) Patent Application Publication
(10) Pub. No.: US 2014/0288971 A1
(43) Pub. Date: Sep. 25, 2014

(54) PATIENT SURVEY METHOD AND SYSTEM

(71) Applicant: Vincent J. Whibbs, III, Encinitas, CA (US)

(72) Inventor: Vincent J. Whibbs, III, Encinitas, CA (US)

(73) Assignee: MARBELLA TECHNOLOGIES INCORPORATED, Encinitas, CA (US)

(21) Appl. No.: 14/222,889

(22) Filed: Mar. 24, 2014

Related U.S. Application Data
(60) Provisional application No. 61/805,060, filed on Mar. 25, 2013.
(60) Provisional application No. 61/950,914, filed on Mar. 11, 2014.
(60) Provisional application No. 61/969,206, filed on Mar. 23, 2014.

(51) Int. Cl. G06Q 50/22; G06Q 10/10

(52) U.S. Cl. CPC G06Q 50/22; G06Q 10/10
USPC 705/3

(57) ABSTRACT

A method, system, and non-transitory computer readable medium for surveying patients and others in a healthcare facility with real-time feedback, response, analysis, and reporting are provided. The method includes receiving by an interactive device inputs from a user in response to questions in a survey; upon completion of the survey, submitting the completed survey to a survey processing system; analyzing the completed survey by the survey processing system; processing one or more alerts based on the inputs received in response to those questions for which an alert trigger has been met, wherein an alert status is identified as an active alert; receiving and documenting details for each resolved alert, wherein the alert status is changed to a resolved alert; and outputting the completed survey to a display device, wherein the output includes the response to each question and details for each active and resolved alert.

### CROSS REFERENCE TO RELATED APPLICATIONS

This application claims priority to and the benefit of U.S. Provisional Application No. 61/805,060 filed Mar. 25, 2013, U.S. Provisional Application No. 61/950,914 filed Mar. 11, 2014, and U.S. Provisional Application No. 61/969,206 filed Mar. 23, 2014, all of which are incorporated by reference herein in their entirety.

### FIELD OF THE INVENTION

The present application relates to a method, system, apparatus, and non-transitory computer readable medium for surveying patients and others in a healthcare facility with real-time feedback, response, analysis, and reporting.

### BACKGROUND OF THE INVENTION

Healthcare providers have until now operated under Fee-for-Service (quantity model) but the Affordable Care Act has set into motion the change to Pay-for-Performance (quality model). The HCAHPS (Hospital Consumer Assessment of Healthcare Providers and Systems at http://www.cms.gov) survey component is a standardized, publicly reported survey of patients' perspectives of hospital care. The HCAHPS Survey is a survey instrument and data collection methodology for measuring patients' perceptions of their hospital experience. While many hospitals have collected information on patient satisfaction for their own internal use, until HCAHPS there was no national standard for collecting and publicly reporting information about patient experience of care that allowed valid comparisons to be made across hospitals locally, regionally and nationally. Hospitals implement HCAHPS under the auspices of the Hospital Quality Alliance (HQA).

The HCAHPS survey asks discharged patients 27 questions about their recent hospital stay. The survey contains 18 core questions about critical aspects of patients' hospital experiences (communication with nurses and doctors, the responsiveness of hospital staff, the cleanliness and quietness of the hospital environment, pain management, communication about medicines, discharge information, overall rating of hospital, and would they recommend the hospital). The survey also includes four items to direct patients to relevant questions, three items to adjust for the mix of patients across hospitals, and two items that support Congressionally-mandated reports.

Customer service is an area that US healthcare providers have traditionally struggled, relying on retrospective surveys that do little to impact meaningful positive change. The problem is that current tools hospitals use to measure patient satisfaction are retrospective. Correcting negative patient experiences after the fact is very difficult.

A number of patents exist that address patient surveys, including U.S. Pat. Nos. 8,392,215, 8,274,360, 8,225,093, 8,032,398, 8,024,367, 7,860,233, 7,565,615, 7,551,078, 7,539,696, 7,493,264, 6,151,581, and 5,536,084, and Application No. 20060206011, all incorporated herein by reference. However, many of these systems are generally directed to predicting risks of a medical condition or progression of a medical condition using survey questions combined with diagnostic data after the fact.

Accordingly, there is a need in the art for a system for surveying patients and others in a healthcare facility with real-time feedback and response.

The present invention is designed to address this need.

### SUMMARY OF THE INVENTION

The following description of the invention represents a method, system, apparatus, and non-transitory computer readable medium for surveying patients and others in a healthcare facility with real-time feedback and response.

The present invention helps hospitals improve the patient perception of care/HCAHPS scores. It allows providers to collect patient perception of care data in real-time. If service deficiencies are present appropriate staff members are auto-notified so service recovery can take place prior to the patient/family member departing.

Features of the invention can be implemented in numerous ways, including as a system, a method, a computer site/portal, or a non-transitory computer readable medium. The invention preferably relies on a communications infrastructure, for example the Internet, wherein individual interaction is possible. Several embodiments of the invention are discussed below.

As a method, the invention comprises computer-implemented steps for sending and receiving information for system management such as the creation of surveys and alerts, and for operation such as using and processing the surveys and sending alerts. The steps further include computer processing of the information and generating outputs, including customized surveys, alerts, and social media updates. Embodiments include a computer-implemented method for patient surveying, comprising: receiving by an interactive device inputs from a user in response to questions in a survey answered by a person being surveyed; upon completion of the survey, submitting by the interactive device the completed survey to a survey processing system in communication therewith; analyzing the completed survey by the survey processing system; processing one or more alerts based on the inputs received in response to those questions for which an alert trigger has been met, wherein an alert status is identified as an active alert; receiving and documenting details for each resolved alert, wherein the alert status is changed to a resolved alert; and outputting the completed survey to a display device, wherein the output includes the response to each question and details for each active and resolved alert.

Further embodiments include wherein the alert trigger is based on one or more of a numerical score, a numerical threshold, and a text matching; wherein processing the one or more alerts comprises sending alerts to one or more personnel previously identified to receive the alert; wherein additional information is sent along with the alert wherein the additional information to be sent has been previously tagged in the survey to accompany the alert; wherein analyzing the completed survey by the survey processing system further comprises: identifying positive patient experience feedback from the completed survey, and communicating the positive patient experience feedback to one or more social media platforms; wherein the alerts are set to be triggered for both negative and positive situations; wherein the alerts are adapted based on location such that processing the one or more alerts comprises sending alerts to one or more personnel based on a location where the alert is triggered; wherein analyzing the completed survey by the survey processing system further comprises: outputting trending information based on one or more benchmarking questions previously designated and categorized based on core areas, wherein the benchmarking questions allow for comparison to other hospitals for these core areas; and wherein one or more questions in the survey are specifically adapted to address patient perception of care and associated HCAHPS (Hospital Consumer Assessment of Healthcare Providers and Systems).

Further embodiments also include providing one or more available surveys to the user via the interactive device; receiving by the interactive device a selection of a survey from the one or more available surveys; creating the one or more available surveys by building a series of questions using a survey creation tool, wherein the tool is adapted for: creating a new survey question, setting an alert for each question, setting a trigger for each alert, and setting a recipient for each alert; pre-populating into the survey one or more data based on identifying information for the patient; selectively outputting one or more completed surveys to a display device based on those surveys completed by a particular user; filtering of output reports to provide for one or more of an alerts triggered report by user, an alerts received report by user, an all alerts report by facility, an unresolved alerts report by facility, an average alert resolve time report, a sortable all surveys summary report, a recent logins report, a user login count, a user activity report, an alert summer report, and an average score report for data collected; providing an association module for associating a staff member to one or more assigned patients, the module dynamically generating a daily rounding list that provides access to completed surveys, alerts and notes associated with each patient of the one or more assigned patients for use by the staff member during patient rounding.

As a computer system, part of the invention generally includes a database and a processor unit. The processor unit operates to run an application that includes modules or tools for survey creation and management, account management, executing surveys, and reviewing surveys. Tools for survey management are used for the creation of surveys and alerts. Tools for executing surveys are used for conducting and processing the surveys and sending alerts. Tools for reviewing surveys are used for providing an interactive dashboard of completed surveys. The system is designed to process the information and generate outputs, including customized surveys, alerts, and social media updates. The outputs may include print or electronic media. Part or all of the data can also be sent electronically and maintained on a server for confidential access with typical browsers. The data may also be transmitted and viewed by other well known techniques such as email, text messaging, paging, and the like. If the system is implemented as a computer web site (accessible via the Internet or an intranet), the site is preferably viewed with a client web browser as an HTML document with linking capabilities, or the like, through a secure server having a database associated therewith. Embodiments herein include a system for patient surveying, comprising: an interactive device having a processor and input device, the interactive device in communication with a survey processing system having a processor, and a series of executable modules stored in memory for implementing the method described herein.

As a non-transitory computer readable medium containing program instructions for collecting, analyzing and generating output, an embodiment of the invention includes computer readable code devices for interacting with a user as noted above, processing that data, and generating printed or electronic media for that user. Embodiments herein include a non-transitory computer readable medium containing program instructions for implementing the method for patient surveying when executed by a processor, as described herein.

In certain embodiments, the present invention includes a Mobile Rounding Platform to conduct the surveys which is a rounding tool that allows staff to collects customer feedback (via customized survey questions) and notifies (alerts) appropriate team members if there is a perceived service issue. The present invention also includes a Patient/family Member Self-Service Platform where patients/family members can “self-service” and use the system to give feedback while at facility from any web-enabled or similarly connected device. A goal is to improve the patient perception of care and associated HCAHPS (Hospital Consumer Assessment of Healthcare Providers and Systems).

For example, in one embodiment, the implementation of Mobile Rounding Platform is as follows: Step 1: Determine for the healthcare provider the “biggest bang for the buck” opportunities for improving the patient perception of care and associated HCAHPS. Step 2: Customize the system by creating survey questions and alert triggers for appropriate departments. Step 3: Facility team members use mobile devices to round on patients/family members using the system with customized questions specific to area/department needs. Step 4: The system monitors responses in real-time and triggers alerts to appropriate service recovery team members when needed. Step 5: After receiving alert, service recovery team member can intervene before patient/family member departs. As a result, patient perception of care and HCAHPS improve.

A Readmission Case Manager is also provided. It allows providers to collect data during in person patient visits in the home and telephonic interviews. The system cues providers for key indicators that are associated with decreasing readmissions.

A Patient/family Member Self-Service Daily Check-in is also provided. Patients/family members can do a self-service daily check-in assessment. Clinical rules built into the system can analyze data and trigger providers. When the system determines that the patient is trending negatively, it can alert the provider so they can intervene and avoid a costly readmission. A goal is to decrease readmissions/improve financials.

In one embodiment, the implementation of the Readmission Case Manager is as follows: Step 1: The system/survey is customized to allow hospital to capture critical information associated with reducing readmissions. The information can be captured three different ways, for example. Step 2: Hospital team rounds on patients after discharge: Option 1: Face-to-face interviews with the patient in their home using the mobile device to capture all critical information Option 2: Telephonic interviews with the patient using the mobile device or the PC based application Option 3: Patient/Family Member Self-Service Daily Check-in functionality Step 3: The system monitors and analyzes responses in real-time and triggers alerts to appropriate facility team members when the system determines that answers indicate the patient is trending negatively. As a result, readmissions decrease/financials improve.

Many leading US healthcare providers see the bigger financial impact associated with patients becoming smarter consumers of healthcare dollars and choosing providers based on a plethora of comparison websites. A goal is to improve facility perception in the community using a social media connectivity platform.

In one embodiment, the implementation of the social media connectivity platform is as follows: Step 1: While rounding on patients/family members using the system, application providers can transmit positive comments to a variety of social media platforms. As a result, positive patient and family facility reviews are promoted and volume increases.

Features and advantages of the present invention are numerous. Using mobile technology, the system empowers healthcare providers to collect patient perception of care data in real-time while rounding. It also allows patients and family members to utilize their personal mobile devices while at the healthcare facility to give real-time feedback regarding their perception of care. Using customizable, mobile technology-based surveys specifically designed for healthcare, the system helps provider organizations hear their patients' perception of care in real-time. If service deficiencies are present, appropriate staff members are immediately auto-notified via text message, email or pager so that they can respond as soon possible to the issue and implement service recovery prior to the patient/family member departing. All service recovery issues are tracked to completion ensuring the facility has done everything possible to promote the best care possible. For healthcare organizations that have implemented patient rounding, the system eliminates all the associated paperwork and manual reporting processes. For those facilities that have not implemented patient rounding, the system serves as a great foundation for ensuring rounding is implemented correctly and streamlines the complete rounding process while tracking patient and family issues and concerns.

As a result, the system helps healthcare providers: Improve the patients and their families' perception of care; excel on HCAHPS and other healthcare provider satisfaction surveys; and elevate the facility's customer service reputation in the community.

The system helps healthcare organizations understand their care delivery environment and patient experience goals. Once key areas are defined through analysis of HCAHPS and/or retrospective third party data, the system surveys are customized with emphasis on alerting staff when patient perception falls below the acceptable norm. Compatible with both the mobile operating systems (e.g., Apple and Android), the system can be installed in a short amount of time.

Further objects and advantages of our invention will become apparent from a consideration of the drawings and the technical description.

All patents, patent applications, provisional applications, and publications referred to or cited herein, or from which a claim for benefit of priority has been made, are incorporated herein by reference in their entirety to the extent they are not inconsistent with the explicit teachings of this specification.

### BRIEF DESCRIPTION OF THE DRAWINGS

A more complete appreciation of the invention and many of the attendant advantages thereof will be readily obtained as the same become better understood by reference to the following detailed description when considered in light of the following drawings, wherein:

FIG. 1 is a block diagram of a hardware implementation of an embodiment of the invention.

FIG. 2 is a flow chart implementation of an embodiment of the invention.

FIG. 3 is a sample screen shot of a survey for inpatient rounding in an embodiment of the invention.

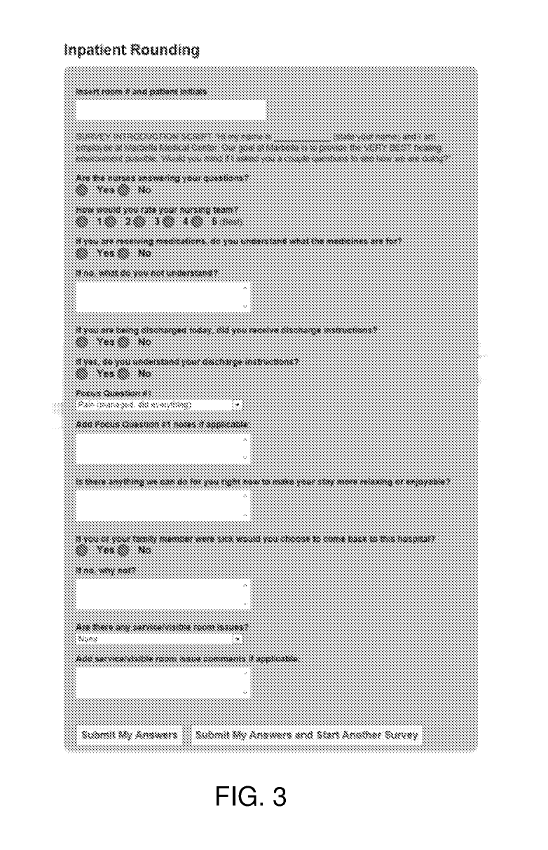

It should be understood that in certain situations for reasons of computational efficiency or ease of maintenance, the ordering of the blocks of the illustrated flow charts could be rearranged or moved inside or outside of the illustrated loops by one skilled in the art. While the present invention will be described with reference to the details of the embodiments of the invention shown in the drawing, these details are not intended to limit the scope of the invention.

### DETAILED DESCRIPTION OF THE PREFERRED EMBODIMENTS

Referring now to the drawings, wherein like reference numeral designate identical or corresponding parts throughout the several views, embodiments of the invention are shown.

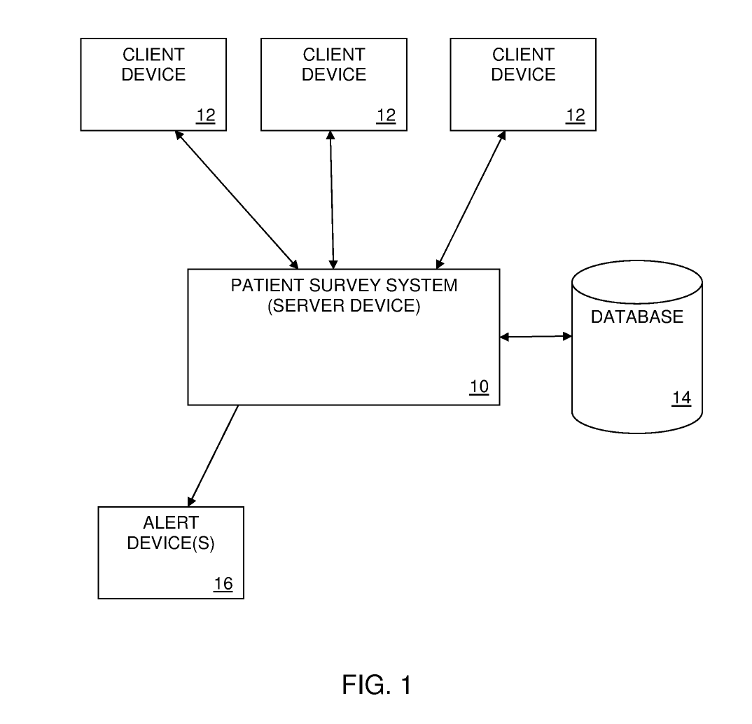

The system in accordance with a preferred embodiment of the present invention provides a survey system and data collection methodology for measuring patients' perceptions of their hospital experience in real time that provides immediate feedback and response. In an implementation shown in FIG. 1, the present invention generally comprises a web-based application running on a server 10 accessible by a client device 12, including any of a number of web-enabled devices, to communicate with the application over the Internet or intranet. The application is adapted to by processed by a processor of the server to implement features and tools of the invention, including sending data to and receiving data from the client devices 12, processing data, storing data (such as patient surveys) on a database 14 as part of the server or in communication therewith, and sending alerts back to the client devices 12 or to alter devices 16 (such as pagers). If implemented as a web application, the application may be accessed by users over a network such as the Internet or an intranet. The web application generally includes a computer software application that is coded in a browser-supported programming language (such as JavaScript, combined with a browser-rendered markup language like HTML) and uses on a web browser to render the application executable. The present invention also envisions other computing arrangements for the client and server(s), including processing on a single machine such as a mainframe, a collection of machines, using cloud computing, or other suitable means.

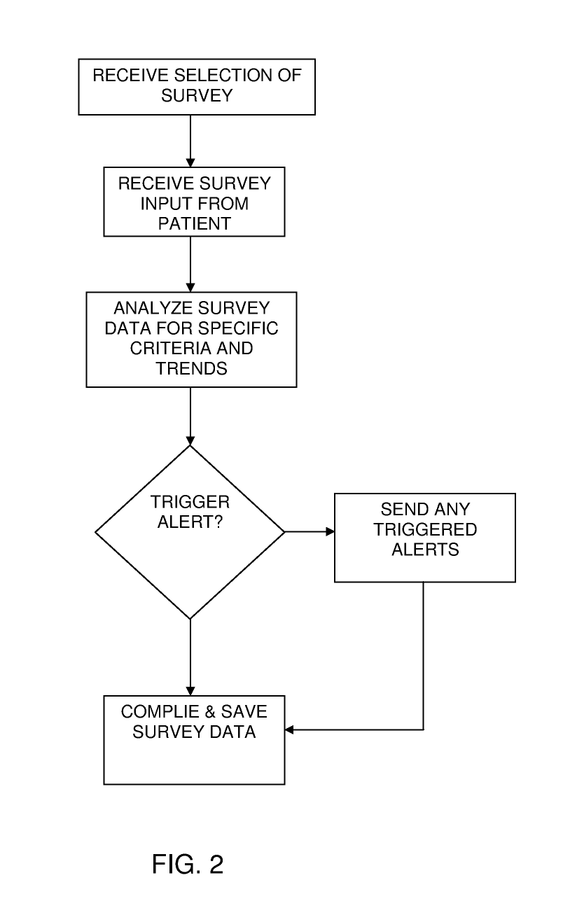

Surveys are preferably taken during rounding using the rounding tool. Generally, as shown in FIG. 2, a provider logs in with his/her mobile device to the system via a web-browser over the Internet and selects a survey from a list of available surveys. Different user security levels may be provided having different user access. The system then loads the questions for the selected survey. Responses from the patient are input into the mobile device. While implementing the survey, the provider may be prompted via the system based on predetermined criteria to ask additional questions or to say certain scripted lines. The system may immediately analyze data for each question or each group/subgroup of questions, and/or may complete the analysis upon completion of the survey. The entered data is analyzed by the system to determine if any of the specific answers require a specific response. If so, an appropriate alert is sent to an appropriate person or department to address the situation.

The entered data is also analyzed by the system to look for data trends, such as when the data is trending negatively. Again, an appropriate alert is sent to an appropriate person or department. Trending may be determined based on a statistical analysis of answers received to survey questions. Trend estimation comprises a statistical technique to aid interpretation of data. Questions and answers may be given different weights to help with determining severity and trends. Trends may be detected even if there are no specific issues that require a specific response. If the overall survey results indicate a negative trend, an appropriate person or department can intervene and address the situation.

The completed survey is submitted and the system then compiles and saves the survey. All of the completed surveys are accessible by authorized personnel in a Completed Survey dashboard and report. All surveys are time/date stamped and any triggered alerts are also marked. When alerts have been resolved, they can be updated as resolved including by whom it was resolved and also the details notes of the resolution effort.

The Self-Service Patient Experience Survey tool proceeds in a manner similar to the provider-assisted survey described above, but without the need for authentication, using a publically-accessible site. This allows patients to give feedback and when service or care issues are present the system will automatically notify the appropriate staff member for follow-up.

Because each provider may have different needs, custom surveys can be created for each provider using the system. Different surveys may be created for different departments or situations. Each question added to the survey can be assigned to a group, a display order, an alert response, a severity, and the like. Scripts can also be added to the survey to prompt the provider to ask additional questions or to say certain scripted lines. Answers to the questions may be set up to be selected from a list and/or free response. Alerts can be assigned to specific answers or thresholds. User contact points for receiving an alert can also be input.

The following is an example of operation and use of the invention, including the creation of customized surveys.

The steps for creating a new survey will now be described in an embodiment of the invention. First log in as the hospital system administrator. Next, click the Create new link. From here, insert the name of the new survey in the Name field, for example, Inpatient Rounding Survey. The final step is to click the Create button.

The steps for creating a new question will now be described in an embodiment of the invention. First log in as the hospital system administrator. Next, click the Edit link next to the survey that you would like to add a question to. From here, click the Create New Question link. Next, select the appropriate Question Type from the drop down menu. For this example a “Score 1 to 5” question is being built. Then, select the appropriate Question Group. This allows users to group certain questions together. In this example, use General. Now you are ready to insert the actual question. In the Text field add your question. For example, “Was our staff attentive to your needs?” Users can then set then rearrange the order of the questions using an up and down arrow methodology. If you want the answer to this question to be included in an alert message check the Include in Alerts box. Likewise, if the question is required check the Required box. The final step is to click the Create button when you are finished.

The steps for creating a new Script Type question will now be described in an embodiment of the invention. The Script Type question is used when you would like to add a script into the survey to remind your team on something they should say or do when talking with a patient or family member. Scripts are often used for entering or exiting a room. First log in as the hospital system administrator. Next, click the Edit link next to the survey that you would like to add a question to. From here, click the Create New Question link. Next, select the appropriate Question Type from the drop down menu. For this example a “Script” question is built. Then, select the appropriate Question Group. General is the default. Now you are ready to insert the actual script. In the Text field add your question. A best practice is to type your question out in Microsoft Word and then copy and paste it into the field. Users can then set then rearrange the order of the questions using an up and down arrow methodology. The Required box does not apply to Script type questions. The final step is to click the Create button when you are finished.

The steps for Setting up a Single Select or Multi-select type question will now be described in an embodiment of the invention. First log in as the hospital system administrator (or other authorized user). Next, click the Edit link next to the survey you would like to add the single select question for. From here, click the Create New Question link next. You are now taken to the screen to insert all the appropriate question information. Next, select the appropriate Question Type from the drop down menu. Select the “Single Selection List” question type. Then, select the appropriate Question Group. In this example, select General. Now you are ready to insert the actual question in the Text field. A best practice is to type your question out in Microsoft Word and then copy and paste it into the field. For example, “Are there any other immediate needs?” Users can then set then rearrange the order of the questions using an up and down arrow methodology. If the question is required, check the Required box. The final step is to click the Create button. You will then click the Manage List link next to the new questions that you just built. You will then be taken to a page that allows you to build out the actual items in the drop down list. Click the Add New link. In the Select List Item Value field, type what you would like to show up in the list for your first selection option. For example, you can add a line item for EVS. Users can then set then rearrange the order of the questions using an up and down arrow methodology. The final step is to click the Create button.

The steps for Setting up an Alert will now be described in an embodiment of the invention. First log in as the hospital system administrator. Next, click the Edit link next to the survey you would like to create a new alert for. From here, click the Edit Rules link next to the question you would like to set up an alert on. Next, click the Create New link. You are then taken to the screen to insert all the appropriate alert information. First, insert the name of the alert for example “Nurse Communication.” This information is important since whatever you insert in this field will be sent to the user when the alert is triggered.

You will then insert the trigger for the alert. Example 1: If the question is a yes/no question type and you want the alert to trigger whenever the answer is “no” then type “no” in the Text Pattern field. Example 2: If the question is a 1-5 question type and you want the alert to trigger for all answers that are 3 or less enter “3” in the Alert Score Threshold field. Example 3: If the question is a single select or multi-select question type and you want the alert to trigger whenever the answer is one of the answer options in the drop down list, type that specific answer in the Text Pattern field.

The final step is to click the Create button. Lastly, establish which user should be notified when the alert is triggered. Next to the alert, click the View/Edit link. At the bottom of the alert you will see the Alert Recipients section. Click the Create New link. In the User Contact drop down menu select the appropriate contact point for the alert to go to.

The steps for setting up a User Contact Point for receiving an alert will now be described in an embodiment of the invention. First log in as the hospital system administrator. Next, click the Account Management link in the upper right hand corner. From here, click the Manage User Records. Next, click the View/Edit link next to the user you would like to add an alert contact point for. Scroll down to the User Contact Points section and click the Create New link. First, in the Contact Method drop down menu select email, SMS or pager (or other indicated contact method). In the Contact Value field insert the appropriate telephone number or email address or contact information. Dashes are not required. For text message alerts select the appropriate cell provider in the Cell Provider drop down menu. If the alert is going to email or a pager then leave blank. If the alert is going to a pager select the appropriate provider in the Pager Provider drop down menu. The final step is to click the Create button.

The steps for Completing a Survey will now be described in an embodiment of the invention. After logging the user will see the Available Surveys page if the user is set up with the Hospital Rounder security level. For all other security levels, users will need to click the Surveys link in the upper right hand corner. Next, Click the Survey you would like to complete. For this example I am going to click the Inpatient Rounding Survey. The user should then complete the questions while speaking with the patient or family member. The final step is to click the Submit My Answers button.

The steps for Managing Alerts will now be described in an embodiment of the invention. After logging the user will see all the completed surveys. All surveys are time/date stamped as well as any alerts that have been triggered (marked as “Alert Active”). Users can then review the completed survey to see details on the alert and then after taking appropriate corrective action they can document that they have resolved the issues by completing the Notes field and clicking the Mark as Resolved button. After doing so the survey and alert now includes the details on the Completed Survey dashboard with the time/data stamp of when the issue was resolved, by whom it was resolved and also the details notes of the resolution effort.

The steps for Self-Service Patient Experience Surveys will now be described in an embodiment of the invention. The system allows providers to set up a patient/family member self-service survey. The system does not require the patient/family member to authenticate into the system but still enables all the previous functionality. This allows patients to give feedback and when service or care issues are present the system will automatically notify the appropriate staff member for follow-up. The system automatically creates a “Public Link” to the survey that providers can use to give patients and family members access to the survey 24/7/365. Providers can then use this hyperlink to associate with a public web address or QR code so that it is easy for patients/family member to access.

The steps for Good News Social Media Connectivity Platform will now be described in an embodiment of the invention. The system will also allow staff members to immediately send positive patient experience feedback out to an unlimited number of review websites such as Yelp, Google, Angies list, Twitter, Facebook, etc. via an API when they are rounding on patients/family members.

Advantages of the invention are numerous, including providing a staff lead, real-time patient perception of care survey system that allows provider staff to collect feedback from patients/family members regarding their perception of care while they are in the facility using mobile devices that connect to the web. With the present invention, the facility can customize the questions and responses they use to meet their specific needs. The system has a variety of different question types including a unique “Script” question type which allows the facility to load a word script into the survey. It does not require an answer to be selected but is put in to remind the provider or staff to say a certain set of words when speaking with a patient or family member.

Moreover, the system allows providers to build in triggers on questions that when answered a particular way it will send an alert to specific user(s). Using an alert triggering functionality, the system allows user to build triggers based on a numerical score and/or text matching. For example, if the question is a 1-5 score type question the user can set an alert threshold at 3 or below. Anytime a survey response is 3 or less the system will trigger an alert to the appropriate staff. Another example, if the question is a “yes/no” type question then a text matching alert can be set up so that when either the word “yes” or the word “no” is selected as the answer the system can trigger an alert depending on which response warrants an alert to be triggered. Another example is for short answer free text questions. A text matching alert can be set up to trigger off any word that might be included in the free text answer. For example, if the facility would like to be alerted anytime a response includes the word “lawyer” or “sue” than they can set up an alert specific to those words. One final example, in a “single-select” or “multi-select” question type where a user can select a response from a drop down box the system can trigger a text matching alert to match any of the question answer responses in the drop down menu. An example of this is a question that say “Are there any service issues in the room” and the question answer options are “EVS, Dietary, Engineering.” An alert can be set to trigger when any of these response are selected using the text matching alert functionality. Using multi-user alerts, the system allows triggers to result is sending alerts to multiple personnel simultaneously. Using multi-platform alerts, the system allows alerts to be triggered to the same person on a variety of communication platforms, including for example, email, text message, and pager.

Using alert management functionality, when an alert is triggered it is marked as “Active Alert” and the system time and date stamps the time of the alert and also notes which user triggered the alert. The system them notifies the appropriate response team via email, text message and or pager. Then the responder can go in and “resolve” the alert by inserting specific comments regarding what they did to resolve the patient issue. When they do this the alert status is changed to “Alert Resolved” and the system time/date stamps the resolution and which user resolved the alert.

Using alert naming functionality, the system allows users to name an alert so that the information captured in the alert name field is sent with the alert. For example, if the survey question is “How would you rate our nursing staff?” The system allows a user to set an alert based on this question and the ability to name the alert something shorter than the actual question so that it can be sent in the alert and will be understandable by the staff member receiving the alert. For example, the alert name could be “Nurse staff rating.”

Using alert information inclusion functionality, the system allows customers to include a variety of other information in the alert beyond the alert name. Any information that is captured in the survey can be included in the alert. For example, if a facility is capturing the patient room number when they complete a survey they have the option of sending this information with the alert. This is accomplished by checking the box “include in alert” on the question setup. By doing so, any information captured in the field associated with that specific question will be sent with the alert.

Using question shorthand functionality, the system allows users to insert a shorthand name to reflect a specific question and associated answer so that it can be sent to a staff member in an alert. For example, if the alert is triggered the customer can set up a shorthand name for Patient Room number or patient identifier to “RM#.”

Patient self-serve real-time survey and associated alert triggering and management functionality—the system allows users to set up a self-service survey that patients and family members can access from their personal mobile devices while they are at the facility. The self-service patient survey has all the alert functionality previously discussed in the staff-lead survey system.

Using the Good news social media connectivity platform, when staff completes patient family member surveys and identifies positive feedback they system, this platform allows staff members to send this positive information out to an unlimited number of review websites such as Yelp, Google, Angie's list, Twitter, Facebook, etc. via an API.

Real-Time Patient Experience Benchmarking Dashboards and Reports—a real-time patient experience benchmarking dashboard and report system is also provided in embodiments herein. This will allow customers to measure their patient experience scores against other facilities in real-time. Currently, retrospective patient satisfaction companies do this but it is all after the fact since they don't survey until after the patient leaves the facility. They send the patient the survey in the mail and then after compiling the survey results they send the hospitals a benchmarking report on how they compare with other hospitals. Embodiments herein provide the following: 1. Give hospitals the ability to designate questions as benchmarking questions. 2. The questions that are selected as benchmarking can be designated in different categories based on the core HCAHPS areas (communication with nurses and doctors, the responsiveness of hospital staff, the cleanliness and quietness of the hospital environment, pain management, communication about medicines, discharge information, overall rating of hospital, and would they recommend the hospital) 3. The benchmarking dashboard and report would then update in real-time. Every time a customer completes a benchmarking designated question the benchmarking dashboards and reports would update as well giving users the ability to see how they are trending and comparing to other hospitals in real-time on the core HCAHPS areas.

The Reward and Recognition alert is also provided in embodiments herein. It works the same way as the other alerts but instead of sending an alert when something is wrong it sends an alert when something is going right. The question asks: “Has anyone gone above and beyond the call of service”—if they answer yes then it send an alert to the supervisor with details on the positive event so the supervisor can give the appropriate reward and recognition. Simple but somewhat unique since most alerts are focused on negative situations rather than a positive situation.

Additional alert specificity—based on location is also provided in embodiments herein. Instead of triggering alters universally, new functionality provides the ability to trigger them based on location in the hospital. For example, without specificity, if there was an issue with “Nurse communication” the alert went to the same person regardless of where the alert was triggered. Now, with specificity, the alert can be location specific so if the a nurse communication alert should go to different people based on where it is triggered, this functionality is supported (i.e. if the alert is triggered in 4 West it needs to go to Nurse Jones and if it is triggered on 3 East then it needs to go to Nurse Smith.

Aspects of the Alert module include the following:

Creating an alert—From the Survey Mgmt click the Edit link next to the survey that you would like to add an alert to; Next, click the Edit Rules link next to the question that you would like. You are then taken to the screen to insert all the appropriate alert information. First, insert the name of the alert for example “Nurse Communication.” This information is important since whatever you insert in this field will be sent to the user when the alert is triggered. You will then need to insert the trigger for the alert. Example 1: If the question is a yes/no question type and you want the alert to trigger whenever the answer is “no” then type no in the Text Pattern field. Example 2: If the question is a 1-5 question type and you want the alert to trigger for all answers that are 3 or less enter 3 in the Alert Score Threshold field. Example 3: If the question is a single select question type and you want the alert to trigger whenever the answer is one of the answer options in the drop down list, type that answer in the Text Pattern field. For example, if one of the drop down list selections is “EVS” and you would like to trigger an alert whenever a user selects EVS from the drop down menu type EVS in the Text Pattern field. The final step is to click the Create button. For Likert scale questions (e.g. 1-4 score question type) and you want the alert to trigger for all answers that are 3 or less enter 3 in the Alert Score Threshold field. For Yes/No and other text based questions enter the word that you would like to trigger the alert on (e.g. if the question is a yes/no question type and you want the alert to trigger whenever the answer is “no” then type no in the Text Pattern field. You can now see that the alert has been successfully set up. The last thing that needs to be done is to establish which user(s) should be notified when the alert is triggered. Next to the alert click the View/Edit link. At the bottom of the alert you will see the Alert Recipients section. Click the Create New link. The user will then be presented with a new screen that allows contacts to be selected for the alert. In the User Contact drop down menu select the appropriate contact point for the alert to go to. Select the appropriate user and then click the Create button. If you have not set up the contact points for system users please refer to the next section: “Setting up a user contact point for receiving an alert.”

Setting up a user contact point for receiving an alert—Click the Manage User Records to add a contact point for a user. Next, click the View/Edit link next to the user you would like to add an alert contact point for. Scroll down to the User Contact Points section and click the Create New link. In the Contact Method drop down menu select Email, SMS or Pager. In the Contact Value field insert the appropriate telephone number or email address. Do not insert dashes for text message numbers. For text message alerts select the Cell Provider from the drop down menu. If the alert is going to email or a pager then choose [None]. If the alert is going to a pager select the appropriate provider in the Pager Provider drop down menu. If the alert is going to email or a text message then choose [None]. The final step is to click the Create button

Unit specific alerts—The system allows Hospital System Administrators to set up unit specific alerts. A unit specific alert is when an alert is sent to a specific person based on the unit the survey was completed on. To create a new unit specific alert recipient click the Create New button. Next select the user contact for the alert and which units are associated for that user with the alert. Select which User Contact you would like the alert to go to. Select which units are specific for that user contact. The system will then show which contact points are associated with the alert based on unit. The system allows you to edit which units are associated with a specific user contact at any time by clicking the Edit link. Likewise you can delete a user contact for an alert at any time by clicking the Delete link.

Alert triggering associated with multi-select questions—Multi-select question types also support alert triggering using the Text Pattern alert option. After building the multi-select answer options (example below) the user can set up an alert by using the Text Pattern option and inserting the list item answer (exact spelling and spacing required) that will trigger the alert. The final step is to add the alert recipient just like all other alerts.

Configuring system to sending additional information in the alert—Users can enable the system to send additional information in the alert message by checking the Include in Alerts checkbox for any question. By checking this box any information inserted in the survey for this specific question will be sent in the alert message. Users can insert a note into the Question Shorthand to help identify the question that the additional information is associated with. For example, this question is a free text question that is asked if the survey respondent said they would not return to the facility. The question shorthand could be “Reason.” “Reason” is what was inserted into the shorthand field. “The nursing team was rude” was what was collected by the rounding team member when they survey the patient and/or family member. Notice: Email, text message and pager alerts are not considered secure from a PHI perspective so it is normally not put in a field that is going to be sent with a text message

Resolving alerts—Alerts can be resolved from any of the following reports: My Completed Surveys; All Completed Surveys; My Alerts (Triggered); My Alerts (Received); All Alerts; Unresolved Alerts; From any of these reports the user should click the View or View Survey link. Example 1: My Alerts (Triggered), My Alerts (Received), All Alerts. Example 2: My Completed Surveys and All Completed Survey View. Example 3: Unresolved Alerts View. After clicking the View or View Survey link the user will then be presented with the option to resolve the alert. To resolve the alert click the Resolve link. The user should then insert the resolution notes. Once this is completed the resolution notes and time/date stamp will appear on the report. The resolution notes and time/date stamp will appear on the report

Aspects of the Daily Census and Search module include the following:

Daily census integration functionality overview—With daily census integration, providers are presented with a list of patients that are present in their units on a daily basis. This patient list serves as a worklist of patients that need to be rounded on that day. Patient information is prepopulated into the survey form and when a survey is completed the associated patient is removed from the rounding worklist. Integration also allows for advanced patient search capabilities as well as advanced patient note taking functionality.

Starting a survey using the daily census integration—To start a new survey the user needs to first click the Patients tab in the main navigation bar. The user will then be presented with users that are in their unit. From there the user should click the Patient Name that they would like to round on. Click the Patients link in the main navigation bar to see a list of patients that are in the user's unit. Click the Patient Name to begin a survey with the name and room number prepopulated into the survey. The Patient Name and Room # will be prepopulated into the survey. The Patient Name and Room # will be prepopulated into the survey. All other survey completion functionality works the same as survey completion without daily census integration.

Patient search and note taking—With daily census integration, users can search for patients as well as track patient experience notes associated with the patient. To see previous surveys associated with a patient and any associated notes, click on the Previous Surveys link next to the patient name when on the My Patients screen. Click the Previous Surveys link to view previous surveys associated with a patient and any associated notes. Type the patient name into the search field to find previous surveys, alerts and associated patient experience notes for a specific patient. The system will take users to the Search Results screen. Here the user will see all previous surveys, alerts and any patient experience notes associated with the patient. To see the item of interest click the associated link. To add a note about the patient click the Add Note button and then after adding the note click the Save button. Click the associated links to view surveys, alerts and notes. To add a note click the Add Note button.

Setting patient name and room number fields to support integration—The system will prepopulate the patient name and room number into the survey for the user. To enable this set up a “Room #” question and also a “Name” question for the specific survey. The question type for these questions need to be set as “Patient Name or ID.” For the patient room number type in the Question Text field “Room #.” Likewise, for the patient name question type “Name” in the Question Text field. Click Save when you are done. The integration functionality will now recognize those fields and automatically insert the patient name and room number into the survey when the user clicks on the patient name. Select Patient Name or ID for the Question Type and then type Room # for the room number question and Name for the patient name question.

Aspects of the Dashboards module include the following:

Dashboards page—When users click the Dashboards link in the top navigation bar they are sent to page that lists all available dashboards for the facility.

Completed Survey Data Dashboard—The Completed Survey Data dashboard shows high level data on all surveys (survey counts, user login counts, surveys by user and unit). Dashboard options are listed below: 1. Date Ranges. Date ranges can be changed to manipulate the data. After changing the date range click the green & blue circle. 2. Threshold. Users can add a “threshold” line to any graph to easily show if an item is above/below a certain level. After inserting the threshold level click the green & blue circle arrow icon to apply the threshold line to the graph. 3. Theme. Users can change the color scheme of any graph by changing the theme. After selecting a new theme click the green & blue circle arrow icon to apply it. 4. View Report. Users can view the data associated with any graph by clicking the “View Report” link below every graph. 5. Save as Default. Once changes have been made users can make the changes the default going forward by clicking the “Save as Default” link. 6. Add to Personal Dashboard. Each user can have a personal dashboard that allows them to just show the graphs that are most important to them. To add a graph to the personal dashboard click on the “Add to Personal Dashboard” link. 7. Printer Friendly version. User can get a printer friendly version of each graph by clicking the printer icon associated with each graph.

Customized Questions Data Dashboard—The Customized Questions Data dashboard shows data on all the facility specific questions. To add data graphs to this dashboard: Select the survey you are interested in graphing data on. The system will then display the question specific to that survey. Select the question from the survey that you would like to graph the data. Other Functionality: 1. Delete. If you want to remove a graph from this dashboard click the “Delete” link. You can always add it back later if you change your mind. 2. All other functionality works the same way as the Completed Survey Data dashboard.

Personal Dashboard—The Personal dashboard shows all graphs that the user has selected to be on a dashboard that is specific to them. Specific Functionality: 1. Remove from Personal Dashboard. If you want to remove a graph from this dashboard click the “Remove from Personal Dashboard” link. You can always add it back later if you change your mind. 2. All other functionality works the same way as the Completed Survey Data dashboard

Ability to graph units side-by-side—The dashboards allow users to graph unit data side-by-side for easier comparison. To do this select the appropriate units and then select the survey you would like to graph.

Ability to include data points on graphs—Users can include data points on the graphs which also carry over to the printer friendly version. To include the data points simply click the Show Notes checkbox. After clicking the Show Notes checkbox the graph will then add the data points.

Daily, Weekly, Monthly, Annual data view options—Users have a number of options for displaying the data. The view the data in a daily, weekly, monthly format check the appropriate radio button and then click the refresh symbol.

Aspects of the Reports module include the following:

Reports page—When users click the Reports link in the top navigation bar they are now sent to a new page that lists all available reports for the facility.

My Completed Surveys Report—The My Completed Surveys report shows all surveys completed by the user that is logged in. The user can sort this report by a variety of date ranges. The My Completed Surveys report can also be sorted by any of the column headings in the report. Hospital System Administrators can also View, Edit or Delete any survey from this screen (Responder & Rounder users only have the View and Edit options). The report also has paging functionality to allow for easy searching through longer search results.

All Completed Surveys Report—The All Completed Surveys report shows all surveys completed for all users associated with the facility. This report has all the same functionality as the My Completed Surveys report.

My Alerts (Triggered) Report—The My Alerts (Triggered) report shows all alerts that have been triggered by the signed in user. The report can by filtered by a variety of date ranges as well as by any of the report column headings. It will show who the alert went to and when the alert is resolved it will show when it was resolved and any resolution notes that have been associated with the alert.

My Alerts (Received) Report—Similar to the My Alerts (Triggered) report the My Alerts (Received) report shows all alerts that have been sent to a specific user. The report can by filtered by a variety of date ranges as well as by any of the report column headings. To resolve the alert the user should click the View Survey link and then insert the resolution notes. Once this is completed the resolution notes and time/date stamp will appear on the report.

All Alerts Report—The All Alerts report shows all alerts that have been triggered for the facility. The report can be filtered by a number of date options, by user, by unit and also be any of the report column headings.

Unresolved Alerts Report—The Unresolved Alerts report shows all alerts that have not been resolved by the facility. The report can be filtered by a number of date options, by unit and also be any of the report column headings.

Average Alert Resolve Time Report—The Average Alert Resolve Time report shows the average time it is taking to resolve alerts. The report can be filtered by a number of date options and by unit. The system also produces four different graphs on how the average resolve time is trending.

Summary Report—All Surveys—The All Surveys report allows users to review high level survey volume data. Users to sort the data by unit, date, and user. The report can be sorted by the report column headings and the system produces easy to use visual data graphs. There is also a printer friendly page view.

Summary Report—Recent Logins—The Recent Logins report shows the most recent login by all users. The report can be filtered by unit and also the report column headings. There is also a printer friendly version and also paging functionality to allow for easy searching with longer reports.

Summary Report—User Login Count—The User Login Counts report shows total logins for each users. The report can be sorted by unit, date and user. The report can be sorted by the report column headings and the system produces easy to use visual data graphs. There is also a printer friendly version and also paging functionality to allow for easy searching with longer reports.

Summary Report—User Activity—The User Activity report shows all specific activity in the system by all users. The report can be sorted by date and by the report column headings.

Summary Report—Alert Summary—The Alert Summary report shows the total alert triggered by type. The report can be sorted by unit, date and user. The report can be sorted by the report column headings and the system produces easy to use visual data graphs. There is also a printer friendly version and also paging functionality to allow for easy searching with longer reports.

Summary Report—Average Score—The Average Score report shows all the specific data collected on each question. Percentages are calculate for each question as well as average score when appropriate. The report can be sorted by unit, date and user. The report shows year to date information (YTD) and also allows for side by side comparison of units. The repot can also be exported to Excel for more details review and manipulation.

Resolving alerts from the report section—Alerts can be resolved from any of the following reports: My Completed Surveys; All Completed Surveys; My Alerts (Triggered); My Alerts (Received); All Alerts; Unresolved Alerts; From any of these reports the user should click the View or View Survey link. After clicking the View or View Survey link the user will then be presented with the option to resolve the alert. To resolve the alert click the Resolve link. The user should then insert the resolution notes. Once this is completed the resolution notes and time/date stamp will appear on the report. The resolution notes and time/date stamp will appear on the report.

Paging functionality for the My Completed Surveys and All Completed Surveys reports—To allow for faster page load times and better usability, the system has paging functionality for the My Completed Surveys and All Completed Surveys reports.

View in Microsoft Excel option—For the following report users can now easily export the results to Microsoft Excel by clicking the Export to Excel button: My Completed Surveys; All Completed Surveys; Average Score Report.

Printer friendly option for reports—The system gives users a “printer friendly” option for the reports. To view a printer friendly version of the report simply click the Printable View button.

Multiple unit report filtering—The system supports filtering the reports by multiple units simultaneously. To filter a report by multiple units simply select the appropriate units and click the Apply Filter button.

Average Score report—Year to Date (YTD) vs. selected timeframe Side by Side comparison—The Average Score report shows a column for Year to Date data as well as a column for the selected time frame.

Average Score report—Side by Side unit comparison—The Average Score report allows users to compare unit performance/scores side by side. The user can select an unlimited number of units to compare. To run the comparison, simply select the appropriate units and clicks the Apply Filter button.

Ability to print dashboard graphs separately—The system supports printing each of the dashboard graphs by themselves. To print an individual graph click the printer icon associated with the appropriate graph. After clicking the printer icon you will be presented with a screen that will allow you to print the graph by itself.

Ability to mass delete surveys—Hospital system administrators have the ability to mass delete surveys from the My Completed Surveys and All Completed Surveys reports. To mass delete surveys simply check the surveys you would like to delete and then click the Delete Selected Items button.

Aspects of the Surveys module include the following:

Survey management overview screen—On the Account Mgmt screen click the Manage My Surveys manage all of your surveys. Creating a new survey—1. Click the Create New link to create a new survey. 2. Insert the name of the new survey in the Name field. 3. If you want the user who is completing the survey to be logged in click the Require User to be Logged In checkbox (this is the default setting). 4. Click the Create button when done.

Modifying a survey—To edit a survey click the Edit link next to the appropriate survey. After clicking the Edit link you will be presented with a screen that will allow you to edit all features of a survey. To make the survey available for use check the Publish box. To edit a specific question click the Edit link next to the appropriate question. To edit an alert rule for a specific question click the Edit Rules link next to the appropriate question. To delete a specific question click the Delete link next to the appropriate question. Click the Save button to finalize changes. Use the arrows to reorder the questions.

Deleting a survey—To delete a survey click the Delete link next to the appropriate survey. You will be given a confirmation screen before the delete is finalized.

Creating a new question—To create a new question click the Create a New Question link. After clicking Create New Question link you will be presented with the Create Question screen. Question Group—if you would like to group your questions within the survey you can do so by selecting a specific group. Most often questions are set to General for the group type. Question Type—select the type of question you would like to set up (e.g. Likert Scale, Yes/No, Short Answer, Single Selection, Multiple Selection). Text—insert your question in this field. A best practice is to type your question out in Word and then copy and paste it into the field. For example, Was our staff attentive to your needs? Question Shorthand—this field is associated with sending alerts and will be covered under the Creating a new alert section. Include in Alerts—if you want the shorthand field of this question to be included in an alert message check the Include in Alerts box. Required—if you want to make this question required to be completed check the Required box. Min Likert Title—this will only appear if you select a Likert Scale type question. Insert what the minimum value represents (e.g. “terrible,” “poor,” “unsatisfactory”). Max Likert Title—this will only appear if you select a Likert Scale type question. Insert what the maximum value represents (e.g. “terrific,” “outstanding,” “awesome”). Publish—check this box if you want this question to appear in the survey. The final step is to click the Create button when you are finished.

Creating a “Script” type question—The Script type question is used when you would like to add a script into the survey to remind your team on something they should say when talking with a patient or family member. Scripts are often used for entering or exiting a room. Select “Script” in the question type drop down box. Insert the actual script In the Question Text field add your question. A best practice is to type your question out in Word and then copy and paste it into the field. All other items for creating a new question are the same as a standard question.

Creating a “Single Selection List” type question—The Single Selection List type question is used when you would like to allow a list of answers via a drop down list that allows user to select a single item. Select “Single Selection List” in the question type drop down box. All other items for creating a new question are the same as a standard question. Next, click the Manage List link next to the “Single Select List” question that you just created. Next, insert the first list item that you would like in the drop down box and click the Add New button. The arrow boxes are used to manage the order of the items in the drop down list.

Creating a “Multiple Selection List” type question—The Multiple Selection List type question is used when you would like to allow a list of answers via a drop down list that allows users to select more than one answer. Select “Multiple Selection List” in the question type drop down box. All other items for creating a new question are the same as a standard question and a Single Selection List question type.

Ability to unpublish a question—The system allows users to unpublish a question. Unpublishing a question removes the question from the survey but does not delete it from the system. To unpublish a question click the Edit link next to the appropriate question. Next, uncheck the Publish checkbox and then click the Save button. After doing this the question will no longer show up on the survey. The question will still appear in the reports area with the answer marked as “not provided.” All previous answers to that question will also appear. For this response the question was unpublished so the answer is automatically marked as “not provided”. When the survey was completed on Oct. 14, 2013 the question was still in the Publish setting so the question was active on the survey so the answer is displayed in the report.

Editing and/or deleting a survey response—To edit a specific survey response click on the Reports link in the main navigation bar. Next, click on the My Completed Surveys link or the All Completed Surveys link to locate the survey response you would like to edit or delete. After using the Filter Options to find the survey response, click on the Edit link next to the survey that you would like to edit. You can then edit any of the information that was originally collected. To delete a survey response, follow the same steps except click the Delete link next to the survey response that you would like to delete. The system will then ask you to confirm that you would like to delete the survey response. When you confirm, the survey response will be deleted from the system.

Managing survey permissions at the survey level—To manage which users have access to a specific survey click the Manage Permission link next to the appropriate survey. Next, use the survey list to select the users that should have access to the specific survey. If all users should be able to access the survey click the Select All link. The users that have access to the survey will be listed in the Selected box on the right hand side of the screen. If you would like to remove all the users from the list click the Clear link. Click the Save button when you are finished with your changes.

Setting up a self-service survey—The system allows providers to set up surveys that can be used by their patients and family members. Patients and family members can complete a self-service survey using their own mobile device or a device that is provided to them by the facility. In order to make completing a survey for patients and family members quick and easy, the hospital system administrator should uncheck the Require user to be logged in checkbox when setting up a self-service survey. Doing so will allow patients and family members to complete a survey without being an official registered user in the system. This can also be completed on the Edit Survey screen. The system also provides a website link that you can use to direct patients and family members directly to that specific self-service survey. The Public Link is listed on the Survey Management page. To access that link, click the Click to view link next to the appropriate survey. You can then use this link with a QR code or a hospital specific URL (e.g. www.hospitalxyzcares.org) for patients to use when wanting to access the self-service survey. This is also the link you should use if you are sending this self-service survey to patients or family members via email after they depart the facility if you are using the survey post discharge. After clicking the Click to view link a new page will open which will show the unique survey URL address for that survey. This is URL you will point the QR Code or hospital specific URL (e.g. www.hospitalxyzcares.org) to. This is also the link you should use if you are sending this self-service survey to patients or family members via email after they depart the facility if you are using the survey post discharge. When self-service surveys are completed they can be found in the reports by picking Not Assigned for the Unit filter option and the survey will display with the user being Anonymous User—Not Logged In.

Aspects of the Units module include the following:

Adding a new unit—Click the Manage Units link to add a new unit. To add a unit type the unit name or number in the field and click the Add.

Editing a unit—To edit an existing unit click the Edit button next to the appropriate unit. Then type in the name change and click the Update button.

Deleting a unit—To delete an existing unit click the Delete button next to the appropriate unit. The system will then ask you “Are you sure you want to delete this Unit?” Click the OK button to confirm.

Ability to unpublish a unit—Hospital system administrators have the ability to unpublish a unit rather than just delete it. To unpublish a unit simply uncheck the Publish checkbox next to the specific unit. Unpublished units will no longer appear in the unit select options for user setup or report screens. However, any previously completed surveys associated with unpublished units can be found in the reports by using selecting the Not Assigned option in the unit filter area. Use the Not Assigned unit option to find surveys associated with unpublished units.

Aspects of the Users module include the following:

User management overview screen—Clicking the Account Mgmt link in the navigation bar will take the user to the account management screen. This is also the home screen for the hospital system administrator users. This the starting screen for managing users, units and surveys. It is also the screen for setting your facility time zone.

Creating a new user—To create a new user click the Manage User Records link. Next, click the Create New link. You will then be taken to the new user setup screen. Complete all the fields. The system will ask you do double enter/confirm the username and the email address of the user. Both are very important since these are used to reset passwords. Select the appropriate account level: Hospital Rounder—select this level for users that only need access to the surveys. Hospital Responder—select this level for users that need access to the surveys, reports and dashboards. Hospital System Administrator—select this level for the hospital staff members that will be responsible for system management. Insert the Unit for the user is appropriate. The unit is not required but is good for data tracking. The system also allows users to be associated with multiple unit. Simple click all units the user is associated with. Click the Create button. The user is now established. The user will need to login to set their personal password.

Creating a new password—Have the new user insert the username which was established for them during new user setup. Typically, customers use the same username naming convention for other software systems at the facility. The user should then insert the temporary password which is “password123”. Then click the “Log On” button. Have the user insert their personal password. Suggested Password requirements: Must be at least eight (8) characters in length; Must contain at least one (1) uppercase character; Must contain at least one (1) special character (non-alpha); Have the user confirm their password by inserting again. Then click the “Set Password & Login” button. The user should select their Secret Question from the drop down list. The user should then insert their answer. Then click the “Set” button. The user will now be logged into the system with their unique username and password. The user will then be presented with the surveys that have been associated with their user login. If no surveys have been assigned to this user the list will be empty.

Resetting a user password—Click the Manage User Records to reset a user password. Next, click the View/Edit link next to the user that needs to have their password reset. The last step is to check the Reset Password check box and then click the Save button. The user will now be able to log in with their username and the temporary password: Password123.

90-day user password reset overview—The system optionally requires users to reset their passwords every 90 days. Upon attempting to login the user will receive a warning screen letting them know they need to reset their password. They will need to confirm their email address (will be prepopulated is they inserted their previous password correctly) and then click the Next Step button. The user will then need to correctly answer their security question and then click the Next button. The user will then need to choose a new password and enter it in the New Password and the New Password (confirm) fields. When the user clicks the Set Password & Login button their new password will be set and they will logged into the system.

Ability to inactivate a user—The system allows Hospital System Administrators to inactivate a user. This would be used when the system administrator wants to block access to the system for a specific user but does not want to delete the user. To make a user inactive check the Inactive box in the user setup screen. The system also shows which users are inactive on the user management screen. On the user management overview screen hospital system administrators can easily see which users are active and which are inactive. The date the user was inactivated is captured here. Inactive users will no longer appear in the By User filter drop down list in reports. However, surveys completed by users that have been inactivated will still be able to be found in all the reports using the All Users selection in the By User filter.

Deleting a user—Click the Manage User Records to delete a user. Next, click the Delete link next to the user that you would like to remove from the system. You will be then Delete user confirmation screen. When you click the Delete button the user will be removed from the system.

Multiple unit to single user association for non-integrated customers—Non-integrated customers can associate users with multiple unit. To associate multiple units with a single users simply click the appropriate units in the unit selection area in the user edit section. Users associated with multiple units will have the ability to select the appropriate unit when completing a new survey.

Ability to sort users by headings on user management screen—Hospital System administrators can now sort users on the user management screen by any of the column headings (User Name, First Name, Last Name, Account Level and Status).

Managing survey permissions at the user level—Click the Manage User Records to manage a user's survey permissions. Next, click the Manage Surveys link next to the appropriate user. Next, use the survey list to pick the surveys that the user should have access to. If the user should be able to access all the surveys click the Select All link. The surveys the user will have access to will be listed in the Selected box on the right hand side of the screen. If you would like to remove all the surveys from the list click the Clear link. Click the Save button when you are finished with your changes.

Managing survey permissions at the survey level—To manage which users have access to a specific survey click the Manage Permission link next to the appropriate survey. Next, use the survey list to select the users that should have access to the specific survey. If all users should be able to access the survey click the Select All link. The users that have access to the survey will be listed in the Selected box on the right hand side of the screen. If you would like to remove all the users from the list click the Clear link. Click the Save button when you are finished with your changes.

Ability to sort users by headings on user management screen—Hospital System administrators can also sort users on the user management screen by any of the column headings (User Name, First Name, Last Name, Account Level and Status).

Patient Experience Integration and Historic Interaction tracking module—In further embodiments, the system may include this module wherein the system tracks every survey, alert and note associated with a patient in the system using a unique patient identifier (which we receive from the customer hospital information system). The system then presents to the hospital staff member a personalized daily list of patients that they need to round on. This is accomplished by having each staff member associated with a specific unit(s) in the system and then interfacing with the hospital information system daily census report where each patient is also associated with a specific unit. This staff and patient unit association allows the unique daily rounding list to be dynamically generated for the staff member each day. Staff members can then pull up all previously completed surveys, alerts and notes associated with this specific patient before entering the room to do their patient experience rounding. By seeing the historic patient experience data, the staff member can anticipate the patient needs and produce a better patient experience.

Aspects of the Patient Experience Integration and Historic Interaction tracking module include one or more of the following features/modules:

Daily census integration functionality overview—With daily census integration, providers are presented with a list of patients that are present in their units on a daily basis. This patient list serves as a worklist of patients that need to be rounded on that day. Patient information is prepopulated into the survey form and when a survey is completed the associated patient is removed from the rounding worklist. Integration also allows for advanced patient search capabilities as well as advanced patient note taking functionality. All other survey completion functionality works the same as survey completion without daily census integration.

Starting a survey using the daily census integration—To start a new survey the user needs to first click the Patients tab in the main navigation bar. The user will then be presented with users that are in their unit. From there the user should click the Patient Name that they would like to round on.

Patient search and note taking—With daily census integration, users can search for patients as well as track patient experience notes associated with the patient. To see previous surveys, alerts and any associated notes associated with a patient, click on the Previous Surveys link next to the patient name when on the My Patients screen. Users can also use the Search function at the top of the screen to find a patient. The system will take users to the Search Results screen. Here the user will see all previous surveys, alerts and any patient experience notes associated with the patient. To see the item of interest click the associated link. To add a note about the patient click the Add Note button and then after adding the note click the Save button.

Setting patient name and room number fields to support integration—The system will prepopulate the patient name and room number into the survey for the user. To enable this set up a “Room #” question and also a “Name” question for the specific survey. The question type for these questions need to be set as “Patient Name or ID.” For the patient room number type in the Question Text field “Room #.” Likewise, for the patient name question type “Name” in the Question Text field. Click Save when you are done. The integration functionality will now recognize those fields and automatically insert the patient name and room number into the survey when the user clicks on the patient name.

Census Import file layout (see Table 1 below): Column header names are not important but the file contains a header row. Columns are in the order listed below. Date columns are in a valid format (e.g. 9/1/13 or Sep. 1, 2013). File can be comma delimited or tab delimited. Records display on the census list based on the date the file is imported and is visible until midnight that same day. Preferably, Patient Number is the only value that is technically required and should be unique for every patient. Patient Name is used for searching and unit is used for reporting. Room Number, Admit Date and Census date are used for display purposes only.

TABLE 1
Census Import file layout.

| Column | Header | Data Type | Size/Format |
|---|---|---|---|
| 1 | Patient Number | Alphanumeric | 1-255 |
| 2 | Patient Name | Alphanumeric | 1-255 |
| 3 | Room Number | Alphanumeric | 1-255 |
| 4 | Unit | Alphanumeric | 1-50 |
| 5 | Admit Date | Date | mm/dd/yyyy |
| 6 | Census Date | Date | mm/dd/yyyy |

An exemplary system for implementing the invention includes a computing device or a network of computing devices, including handheld computing devices such as smartphones, tablets, portable data devices, etc., preferably in communication with a central computing device via communication means, including a central server based system accessible via the Internet or intranet. In a basic configuration, computing device may include any type of stationary computing device or a mobile computing device. Computing device typically includes at least one processing unit and system memory. Depending on the exact configuration and type of computing device, system memory may be volatile (such as RAM), non-volatile (such as ROM, flash memory, and the like) or some combination of the two. System memory typically includes operating system, one or more applications, and may include program data. Computing device may also have additional features or functionality. For example, computing device may also include additional data storage devices (removable and/or non-removable) such as, for example, magnetic disks, optical disks, or tape. Computer storage media may include volatile and non-volatile, removable and non-removable non-transitory media implemented in any method or technology for storage of information, such as computer readable instructions, data structures, program modules or other data. System memory, removable storage and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by computing device. Any such computer storage media may be part of device.

Computing device may also have input device(s) such as a keyboard, mouse, pen, voice input, touch sensitive input, etc. Output device(s) such as a display, speakers, printer, etc. may also be included. Computing device also contains communication connection(s) that allow the device to communicate with other computing devices, such as over a network or a wireless network. By way of example, and not limitation, communication connection(s) may include wired media such as a wired network or direct-wired connection, and wireless media such as acoustic, RF, infrared and other wireless media.

A interface application (e.g., using a web browser) to provide a graphical user interface (GUI) for connecting to a central application, maintenance (back-end) applications to support the system, database server software and a database associated therewith, and an administrative interface, may all be included in the system. For example, the system may include a web server for storing web pages, and a client computer/device capable of accessing the web pages on server. Server may be any number of known computers, or network of computers, capable of hosting a website. Similarly, client may be any number of known computers, or network of computers, capable of supporting a web browser. Server and client are coupled to one another via a network, such as the Internet or an intranet. To retrieve a web page stored on server, the user of client specifies a URL (uniform resource locator). The specified URL allows web browsing software running on client to initiate communication with server and access the desired HTML page, which a browser interprets and displays on client. The present invention also envisions other computing arrangements for the client and server(s), including processing on a single machine such as a mainframe, a collection of machines, or other suitable means. The client and server machines work together to accomplish the processing of the present invention.

Computer program code for carrying out operations of the invention described above may be written in a high-level programming language, such as C, JAVA, or C++, or scripting language, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller. A code in which a program of the present invention is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD). The present invention can be configured for use in a computer or an information processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general purpose computer, but rather the special purpose computer programmed to perform the disclosed algorithm.

A general purpose computer, or microprocessor, may be programmed to carry out the algorithm/steps of the present invention creating a new machine. The general purpose computer becomes a special purpose computer once it is programmed to perform particular functions pursuant to instructions from program software of the present invention. The instructions of the software program that carry out the algorithm/steps electrically change the general purpose computer by creating electrical paths within the device. These electrical paths create a special purpose machine for carrying out the particular algorithm/steps.

Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It should be understood that the examples and embodiments described herein are for illustrative purposes only and that various modifications or changes in light thereof will be suggested to persons skilled in the art and are to be included within the spirit and purview of this application.

1. A computer-implemented method for patient surveying, comprising:
receiving by an interactive device inputs from a user in response to questions in a survey answered by a person being surveyed;
upon completion of the survey, submitting by the interactive device the completed survey to a survey processing system in communication therewith;
analyzing the completed survey by the survey processing system;
processing one or more alerts based on the inputs received in response to those questions for which an alert trigger has been met, wherein an alert status is identified as an active alert;
receiving and documenting details for each resolved alert, wherein the alert status is changed to a resolved alert; and
outputting the completed survey to a display device, wherein the output includes the response to each question and details for each active and resolved alert.

2. The method of claim 1 wherein the alert trigger is based on one or more of a numerical score, a numerical threshold, and a text matching.

3. The method of claim 1 wherein processing the one or more alerts comprises sending alerts to one or more personnel previously identified to receive the alert.

4. The method of claim 3 wherein additional information is sent along with the alert wherein the additional information to be sent has been previously tagged in the survey to accompany the alert.

5. The method of claim 1 wherein analyzing the completed survey by the survey processing system further comprises:
identifying positive patient experience feedback from the completed survey, and
communicating the positive patient experience feedback to one or more social media platforms.

6. The method of claim 1 wherein the alerts are set to be triggered for both negative and positive situations.

7. The method of claim 1 wherein the alerts are adapted based on location such that processing the one or more alerts comprises sending alerts to one or more personnel based on a location where the alert is triggered.

8. The method of claim 1 further comprising:
providing one or more available surveys to the user via the interactive device;
receiving by the interactive device a selection of a survey from the one or more available surveys.

9. The method of claim 1 further comprising creating the one or more available surveys by building a series of questions using a survey creation tool, wherein the tool is adapted for:
creating a new survey question,
setting an alert for each question,
setting a trigger for each alert, and
setting a recipient for each alert.

10. The method of claim 1 wherein analyzing the completed survey by the survey processing system further comprises:
outputting trending information based on one or more benchmarking questions previously designated and categorized based on core areas, wherein the benchmarking questions allow for comparison to other hospitals for these core areas.

11. The method of claim 1 further comprising pre-populating into the survey one or more data based on identifying information for the patient.

12. The method of claim 1 further comprising selectively outputting one or more completed surveys to a display device based on those surveys completed by a particular user.

13. The method of claim 1 further comprising filtering of output reports to provide for one or more of an alerts triggered report by user, an alerts received report by user, an all alerts report by facility, an unresolved alerts report by facility, an average alert resolve time report, a sortable all surveys summary report, a recent logins report, a user login count, a user activity report, an alert summer report, and an average score report for data collected.

14. The method of claim 1 further comprising providing an association module for associating a staff member to one or more assigned patients, the module dynamically generating a daily rounding list that provides access to completed surveys, alerts and notes associated with each patient of the one or more assigned patients for use by the staff member during patient rounding.

15. The method of claim 1 wherein one or more questions in the survey are specifically adapted to address patient perception of care and associated HCAHPS (Hospital Consumer Assessment of Healthcare Providers and Systems).

16. A non-transitory computer readable medium containing program instructions for implementing a method for patient surveying when executed by a processor, the method comprising:
receiving by an interactive device inputs from a user in response to questions in a survey answered by a person being surveyed;
upon completion of the survey, submitting by the interactive device the completed survey to a survey processing system in communication therewith;
analyzing the completed survey by the survey processing system;
processing one or more alerts based on the inputs received in response to those questions for which an alert trigger has been met, wherein an alert status is identified as an active alert;
receiving and documenting details for each resolved alert, wherein the alert status is changed to a resolved alert; and
outputting the completed survey to a display device, wherein the output includes the response to each question and details for each active and resolved alert.

17. A system for patient surveying, comprising:
an interactive device having a processor and input device, the interactive device in communication with a survey processing system having a processor, and
a series of executable modules stored in memory for implementing a method for patient surveying when executed by a processor, the method comprising:
receiving by the interactive device inputs from a user in response to questions in a survey answered by a person being surveyed;
upon completion of the survey, submitting by the interactive device the completed survey to the survey processing system in communication therewith;
analyzing the completed survey by the survey processing system;
processing one or more alerts based on the inputs received in response to those questions for which an alert trigger has been met, wherein an alert status is identified as an active alert;
receiving and documenting details for each resolved alert, wherein the alert status is changed to a resolved alert; and
outputting the completed survey to a display device, wherein the output includes the response to each question and details for each active and resolved alert.
